(19) United States
(12) Patent Application Publication
(10) Pub. No.: US 2026/0297307 A1
(43) Pub. Date: Oct. 1, 2026

(54) POLYETHYLENE RESIN COMPOSITION FOR BIAXIALLY ORIENTED FILM

(71) Applicant: LOTTE CHEMICAL CORPORATION, Seoul (KR)

(72) Inventors: Jin Ju CHO, Daejeon (KR); Song Ho KIM, Daejeon (KR); Sun Hyung OH, Daejeon (KR); Yun A MOON, Daejeon (KR)

(21) Appl. No.: 18/867,756

(22) PCT Filed: Feb. 22, 2023
(86) PCT No.: PCT/KR2023/002563

§ 371 Date: May 29, 2026

(30) Foreign Application Priority Data
May 27, 2022 (KR) 10-2022-0065423

(51) Int. Cl. C08L 23/0807; C08J 5/18

(52) U.S. Cl. CPC C08L 23/0815; C08J 5/18; C08J 2323/08; C08J 2423/08; C08L 2203/16; C08L 2205/025; C08L 2205/03

(57) ABSTRACT

Disclosed is a polyethylene resin composition for a biaxially oriented film moldable with a biaxial stretcher, exhibiting excellent stretching properties, biaxially stretchable in a wider temperature range, and having excellent thickness smoothness and transparency. The present invention provides a polyethylene resin composition for a biaxially oriented film, wherein the composition includes 5 wt % to 20 wt % of a molecular weight fraction fractionated at a temperature of 35° C. or lower, and 5 wt % to 20 wt % of a molecular weight fraction fractionated at a temperature of 94° C. or higher through analytical temperature rising elution fractionation (a-TREF) analysis.

### TECHNICAL FIELD

The present invention relates to a polyethylene resin composition, and more particularly, to a polyethylene resin composition for a biaxially oriented film.

### BACKGROUND ART

In the plastic-related industry, the market environment is rapidly changing as new issues emerge, including the issue of ocean plastics. Container packaging materials, which are heavily used, are no exception, and in addition to the production of packaging materials, the processed food/beverage and distribution sectors are also required to respond to environmental issues such as plastic waste and greenhouse gas reduction.

Particularly, packaging container-related companies have recognized the need to concentrate on the development of materials capable of reducing the environmental burden, and globally, under the premise of recycling, the development and use of uni-material-related products, and bio-plastics that contribute to the reduction of carbon dioxide (CO₂) are becoming more active.

Globally, polyethylene (PE)-based materials are the mainstream of a uni-material trend. This is because in the process of designing a multilayer film, a sealant layer is first reviewed in consideration of the contents, use, and the like, and since the rate of employing polyethylene in the middle sealant layer is relatively high, when the entire product is made of a uni-material, the surface material is likely to be polyethylene-based as a result.

In the United States, a system for recovering and recycling polyethylene products is being established, so that it is expected that the supply of polyethylene-based materials will dominate, and Mitsui Dow Chemical Company, which has raw material resin and film production companies, and the like under its wing, has been focused on developing a uni-material polyethylen-based material. In addition, Dow Chemical Company is changing a pouch material used for film applications having too many functions (dried fruit, frozen food, pet food, etc.) from PET/PE-based materials to PE Uni material-based materials (single product).

Meanwhile, even in a biaxially oriented film, the above-described development trend may continue if a layer is made of a uni-material by replacing previously used biaxially oriented polyamide (BOPA) or biaxially oriented polyethylene terephthalate (BOPET) with biaxially oriented polyethylene with (BOPE), but there has not yet been a case presented that shows satisfactory stretching properties for polyethylene moldable with a biaxial stretcher.

Korean Patent No. 0746253 discloses a polyethylene-based stretched film having excellent Elmendorf tear strength and being uniformly stretchable, but it is difficult to obtain satisfactory strength properties when biaxially stretched with an actually presented composition.

### DISCLOSURE OF THE INVENTION

### Technical Problem

An aspect of the present invention provides a polyethylene resin composition for a biaxially oriented film moldable with a biaxial stretcher, exhibiting excellent stretching properties, biaxially stretchable in a wider temperature range, and having excellent thickness smoothness and transparency.

### Technical Solution

According to an aspect of the present invention, there is provided a polyethylene resin composition for a biaxially oriented film, wherein the composition includes 5 wt % to 20 wt % of a molecular weight fraction fractionated at a temperature of 35° C. or lower, and 5 wt % to 20 wt % of a molecular weight fraction fractionated at a temperature of 94° C. or higher through analytical temperature rising elution fractionation (a-TREF) analysis.

In addition, there is provided a polyethylene resin composition for a biaxially oriented film, wherein the resin composition includes (A) 1 wt % to 30 wt % of a copolymer of ethylene and an olefin having 4 to 10 carbon atoms, the copolymer having a density of 0.860 g/cm³ to 0.910 g/cm³, (B) 60 wt % to 98 wt % of a copolymer of ethylene and an olefin having 4 to 10 carbon atoms, the copolymer having a density of 0.925 g/cm³ to 0.940 g/cm³, and (C) 1 wt % to 10 wt % of a copolymer of ethylene and an olefin having 4 to 10 carbon atoms, the copolymer having a density of 0.940 g/cm³ to 0.970 g/cm³.

In addition, there is provided a polyethylene resin composition for a biaxially oriented film, wherein the resin composition includes 5 wt % to 20 wt % of a molecular weight fraction fractionated at a temperature of 35° C. or lower, and 5 wt % to 20 wt % of a molecular weight fraction fractionated at a temperature of 94° C. or higher through analytical temperature rising elution fractionation (a-TREF) analysis.

In addition, there is provided a polyethylene resin composition for a biaxially oriented film, wherein the (A) copolymer has a melt index (190° C., 2.16 kg load) of 0.2 g/10 min to 6 g/10 min, the (B) copolymer has a melt index (190° C., 2.16 kg load) of 1 g/10 min to 3.5 g/10 min, and the (C) copolymer has a melt index (190° C., 2.16 kg load) of 0.2 g/10 min to 2.5 g/10 min.

In addition, there is provided a polyethylene resin composition for a biaxially oriented film, wherein the (A) copolymer has a glass transition temperature (Tg) of −50° C. to −45° C., the (B) copolymer has a melting point temperature (Tm) of 120° C. 130° C. and a crystallization temperature (Tc) of 110° C. to 115° C., and the (C) copolymer has a melting point temperature (Tm) of 130° C. to 140° C. and a crystallization temperature (Tc) of 115° C. to 125° C.

In addition, there is provided a polyethylene resin composition for a biaxially oriented film, wherein the resin composition has a melt index (190° C., 2.16 kg load) of 1 g/10 min to 3 g/10 min, and a density of 0.920 g/cm³ to 0.940 g/cm³.

In addition, there is provided a polyethylene resin composition for a biaxially oriented film, wherein the resin composition has a tensile strength of 700 kgf/cm² or greater in each of longitudinal and transverse directions measured under the following conditions, a stretching thickness deviation of 15% or less, and a haze of 10% or less.

### [Measurement Method]

Using the above-described resin composition, a biaxially stretched film having a film thickness of 20 μm and a film width of 8 m is manufactured under the conditions of a molding rate of 400 m/min, a longitudinal direction (MD) stretching ratio of 5 times and a stretching temperature of 112° C. to 128° C., a transverse stretching ratio of 9 times and a stretching temperature of 108° C. to 116° C., and a sample of the biaxially stretched film is measured for a tensile strength in accordance with ASTM D882 regulations using a tensile tester (model name: Instron, 4466) under the conditions of a load cell of 100 N and a test rate of 500 mm/min, and then, the manufactured film is cut to a length of 1 m, and measured for a thickness at any point of 8 divided sections thereof to obtain a deviation in comparison with a thickness before stretching, thereby measuring a stretching thickness deviation by averaging the deviations, and the sample is measured for a haze of the stretched film in accordance with ASTM D1003 regulations using a haze meter (model name: Nippon Denshoku, NDH5000).

### Advantageous Effects

According to the present invention, a polyethylene resin composition is provided by mixing three types of copolymers of ethylene and an olefin having 4 to 10 carbon atoms, the copolymers which are different from each other in density in a certain range, and furthermore, the polyethylene resin composition having fraction properties according to specific a-TREF analysis using CFC is presented, so that it is possible to provide a polyethylene resin composition for a biaxially oriented film moldable with a biaxial stretcher, exhibiting excellent stretching properties, biaxially stretchable in a wider temperature range, and having excellent thickness smoothness and transparency.

### BRIEF DESCRIPTION OF THE DRAWINGS

FIG. 1 is a conceptual diagram for describing a TREF analysis method for a resin composition in the present invention.

FIG. 2 and FIG. 3 are graphs showing temperature-elution fractionation curves analyzed by temperature rise elution fractionation using TREF for compositions prepared according to Example 1 and Comparative Example 1, respectively.

### BEST MODE FOR CARRYING OUT THE INVENTION

Hereinafter, the present invention will be described in detail with reference to preferred embodiments. Prior to this, it will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention. Therefore, the configurations of the embodiments described herein are merely the most preferred embodiments of the present invention, and are not intended to limit the technical idea of the present invention. Therefore, it should be understood that there may be various equivalents and modifications that may substitute the embodiments at the time of filing the present application.

In a situation in which a composition exhibiting satisfactory stretching properties has not yet been presented for a layer to be made of a uni-material by replacing typically used BOPA or BOPET with BOPE, the present inventors have confirmed that a polyethylene resin composition having fraction properties according to specific a-TREF analysis using cross-fractionation chromatography (CFC), and furthermore, prepared by mixing three types of copolymers of ethylene and an olefin having 4 to 10 carbon atoms, the copolymers which are different from each other in density in a certain range, is moldable with a biaxial stretcher, exhibits excellent stretching properties, biaxially stretchable in a wider temperature range, and having excellent thickness flatness and transparency, which has led to the present invention.

Therefore, the present invention discloses a polyethylene resin composition for a biaxially oriented film, wherein the resin composition includes 5 wt % to 20 wt % of a molecular weight fraction fractionated at a temperature of 35° C. or lower, and 5 wt % to 20 wt % of a molecular weight fraction fractionated at a temperature of 94° C. or higher through analytical temperature rising elution fractionation (a-TREF) analysis, and the resin composition according to the present invention preferably includes (A) 1 wt % to 30 wt % of a copolymer of ethylene and an olefin having 4 to 10 carbon atoms, the copolymer having a density of 0.860 g/cm³ to 0.910 g/cm³, (B) 60 wt % to 98 wt % of a copolymer of ethylene and an olefin having 4 to 10 carbon atoms, the copolymer having a density of 0.925 g/cm³ to 0.940 g/cm³, and (C) 1 wt % to 10 wt % of a copolymer of ethylene and an olefin having 4 to 10 carbon atoms, the copolymer having a density of 0.940 g/cm³ to 0.970 g/cm³.

In the present invention, the (A) copolymer is an ultra-low density polyethylene, and may have a density of 0.860 g/cm³ to 0.910 g/cm³, preferably 0.870 g/cm³ to 0.910 g/cm³. If the density is out of the above-described range, it is difficult to perform biaxial stretching.

In addition, the (A) copolymer preferably has a glass transition temperature of −40° C. or lower, more preferably, −50° C. to −40° C. In this case, it is possible to prevent degradation in physical properties of a final film when used in a low-temperature environment.

In addition, as the (A) copolymer, a copolymer prepared using a metallocene catalyst may preferably be used, and a copolymer of ethylene and an α-olefin such as 1-butene, 1-hexene, or 1-octene may be used, preferably a copolymer of ethylene and an α-olefin having 6 to 8 carbon atoms may be used, and more preferably, a copolymer of ethylene and 1-hexene or 1-octene may be used. In addition, the melt index (190° C., 2.16 kg load) may be 0.2 g/10 min to 6 g/10 min, preferably 0.5 g/10 min to 2 g/10 min. If a copolymer prepared using a Ziegler-Natta catalyst is applied, a copolymer prepared using an α-olefin having a carbon number other than 4 to 10 is applied as a comonomer to be copolymerized with ethylene, or the melt index is out of the above-described range, it may be difficult to perform biaxial stretching molding. A method for polymerizing the (A) copolymer is not particularly limited, and the (A) copolymer may be prepared by any method such as a vapor method, a solution method, a slurry method, or the like.

The (A) copolymer may be included in an amount of 1 wt % to 30 wt %, preferably 10 wt % to 30 wt %, in the total resin composition. If the content of the (A) copolymer is out of the above-described range, it is also difficult to perform biaxial stretching, and if greater than 30 wt %, mechanical properties are degraded due to a large number of low-crystalline molecules, thereby degrading a final tensile strength.

In the present invention, the (B) copolymer is a linear low-density polyethylene, and may have a density of 0.925 g/cm³ to 0.940 g/cm³, preferably 0.925 g/cm³ to 0.935 g/cm³. If the density is out of the above-described range, it is difficult to perform biaxial stretching.

In addition, as the (B) copolymer, a copolymer prepared using a Ziegler-Natta catalyst may preferably be used to secure a range in which film molding is possible, and a copolymer of ethylene and an α-olefin such as 1-butene, 1-hexene, or 1-octene may be used, preferably a copolymer of ethylene and 1-butene, 1-hexene, or 1-octene, and the melt index (190° C., 2.16 kg load) may be 1 g/10 min to 3.5 g/10 min, preferably 2 g/10 min to 3 g/10 min. If a copolymer prepared using a metallocene catalyst is applied, a copolymer prepared using an α-olefin having a carbon number other than 4 to 10 is used as a comonomer to be copolymerized with ethylene, or the melt index is out of the above-described range, it may be difficult to perform biaxial stretching molding. A method for polymerizing the (B) copolymer is not particularly limited, and the (A) copolymer may be prepared by any method such as a vapor method, a solution method, a slurry method, or the like.

In addition, the (B) copolymer preferably has a melting point temperature of 120° C. to 130° C. and a crystallization temperature of 110° C. to 115° C. such that a final film is biaxially stretchable in a wider temperature range, and accordingly, is biaxially stretchable in a wide temperature range of a stretching process temperature of 108° C. to 128° C.

The (B) copolymer may be included in an amount of 60 wt % to 98 wt %, preferably 65 wt % to 80 wt %, in the total resin composition. If the content of the (B) copolymer is out of the above-described range, it is also difficult to perform biaxial stretching, and if less than 60 wt %, the tensile strength of a film is significantly degraded.

In the present invention, the (C) copolymer is a high-density polyethylene which is mixed to improve the tensile strength of a final film as well as to improve stretching processability and color, and may have a density of 0.940 g/cm³ to 0.970 g/cm³, preferably 0.950 g/cm³ to 0.960 g/cm³. If the density is out of the above-described range, it is difficult to perform biaxial stretching.

In addition, as the (C) copolymer, a copolymer of ethylene and an α-olefin such as 1-butene, 1-hexene, or 1-octene may be used, preferably a copolymer of ethylene and 1-butene or 1-hexene, and the melt index (190° C., 2.16 kg load) may be 0.2 g/10 min to 2.5 g/10 min, preferably 0.2 g/10 min to 1 g/10 min. If a copolymer prepared using an α-olefin having a carbon number other than 4 to 10 is used as a comonomer to be copolymerized with ethylene, or the melt index is out of the above-described range, it may be difficult to perform biaxial stretching molding. A method for polymerizing the (C) copolymer is not particularly limited, and the (A) copolymer may be prepared by any method such as a vapor method, a solution method, a slurry method, or the like.

In addition, in order to further improve moldability by maintaining rigidity of a film in a stretching process and to maximize mechanical properties of a final biaxially stretched film, the (C) copolymer preferably may have a melting point temperature of 130° C. or higher, more preferably 130° C. to 140° C., and may have a crystallization temperature of 115° C. to 125° C.

The (C) copolymer may be included in an amount of 1 wt % to 10 wt %, preferably 3 wt % to 10 wt %, in the total resin composition. If the content of the (C) copolymer is greater than 10 wt %, it is impossible to achieve stretching in a stretching process due to a large number of crystalline molecules, so that fracture may occur.

In accordance with the mixture of the (A) copolymer, the (B) copolymer, and the (C) copolymer as described above, a final resin composition may have a melt index (190° C., 2.16 kg load) of 1 g/10 min to 3 g/10 min, preferably 1.5 g/10 min to 2.5 g/10 min, and may have a density of 0.900 g/cm³ to 0.940 g/cm³, preferably 0.925 g/cm³ to 0.935 g/cm³.

In the present invention, it has been confirmed that when a polyethylene resin composition having the above-described composition is molded into a biaxially oriented film, if the polyethylene resin composition has certain fraction properties in accordance with analytical temperature rising elution fractionation (a-TREF) using cross-fractionation chromatography (CFC), satisfactory strength properties are implemented while showing smooth moldability, biaxial stretching is possible in a wider temperature range, and thickness smoothness and transparency are improved, and specifically, as described, the resin composition according to the present invention may include 5 wt % to 20 wt % of a molecular weight fraction fractionated at a temperature of 35° C. or lower, and 5 wt % to 20 wt % of a molecular weight fraction fractionated at a temperature of 94° C. or higher through the analytical temperature rising elution fractionation (a-TREF) analysis, and may preferably include 10 wt % to 20 wt % of a molecular weight fraction fractionated at a temperature of 35° C. or lower, and 5 wt % to 15 wt % of a molecular weight fraction fractionated at a temperature of 94° C. or higher.

In the present invention, a temperature-molecular weight fraction curve through the a-TREF analysis method is based on Flory Huggins' statistical thermodynamic equation (Equation 1 below), which expresses a phenomenon in which the melting point decreases by a diluent, as a temperature rise elution fractionation method.

$$\frac{1}{{T}_{m}} - \frac{1}{{T}_{m}^{0}} = - ( \frac{R}{Δ Hu} ) ln {N}_{A} \qquad [ Equation 1 ]$$

In Equation 1, Tₘ is the melting point temperature of a pure polymer, Tₘ⁰ is the melting point temperature of a diluted polymer, R is a gas constant, ΔHᵤ is the amount of heat of fusion per repeated unit of a polymer, and N_{A} is the molar fraction of a diluent.

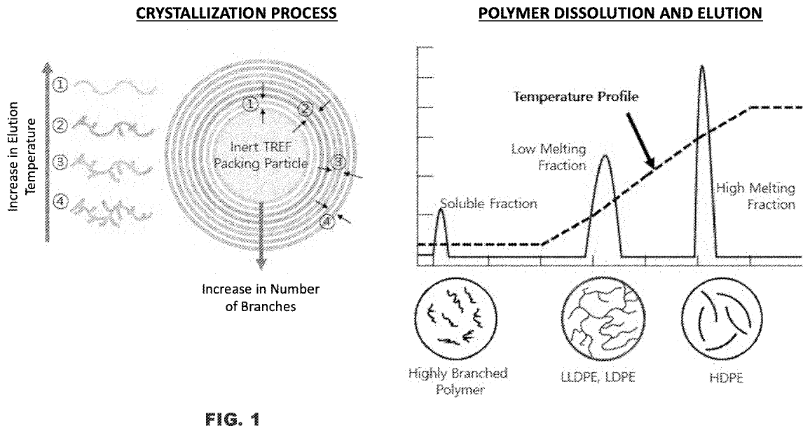

A solvent or comonomer may be referred to as a diluent of a polymer, and the crystallization temperature of a polyolefin decreases as the concentration of the diluent increases. A TREF experiment requires melting a sample and injecting the melted sample in a high-temperature state into a column, followed by gradually lowering the temperature to induce crystallization of the sample, and when a polymer is precipitated inside the column by lowering the temperature, the temperature of the column is gradually increased again according to a temperature increase process, and a sample in which the polymer precipitated in the column is eluted according to the temperature is analyzed, and a molecular weight fraction eluted at each temperature is distinguished (FIG. 1).

The polyethylene resin composition for a biaxially oriented film according to the present invention may be added with a common polyethylene additive so to be applied for various purposes, and for example, an antioxidant, a heat and light stabilizer, an antistatic agent, a lubricant, an antiblocking agent, a preservative, a processing aid, a slip agent, an anti-pressure-sensitive adhesive agent, a pigment, a flame retardant, a foaming agent, and the like may be added thereto in an appropriate amount.

The polyethylene resin composition for a biaxially oriented film according to the present invention may be prepared by mixing and extruding the above-described components according to a typical method known in the art. For example, the above-described components may be introduced into a twin-screw extruder and melt-kneaded to prepare the polypropylene resin composition for a biaxially oriented film.

The polyethylene resin composition for a biaxially oriented film according to the present invention is biaxially stretchable, and exhibits excellent stretching properties, and specifically, may have a tensile strength of 700 kgf/cm² or greater in each of longitudinal and transverse directions, preferably a tensile strength of 950 kgf/cm² or greater in the transverse direction, a stretching thickness deviation of 15% or less, preferably 10% or less, and a haze of 10% or less, preferably 8% or less, as measured under the following conditions.

### [Measurement Method]

Using the above-described resin composition, a biaxially stretched film having a film thickness of 20 μm and a film width of 8 m is manufactured under the conditions of a molding rate of 400 m/min, a longitudinal direction (MD) stretching ratio of 5 times and a stretching temperature of 112° C. to 128° C., a transverse stretching ratio of 9 times and a stretching temperature of 108° C. to 116° C., and a sample of the biaxially stretched film is measured for a tensile strength in accordance with ASTM D882 regulations using a tensile tester (model name: Instron, 4466) under the conditions of a load cell of 100 N and a test rate of 500 mm/min, and then, the manufactured film is cut to a length of 1 m, and measured for a thickness at any point of 8 divided sections thereof to obtain a deviation in comparison with a thickness before stretching, thereby measuring a stretching thickness deviation by averaging the deviations, and the sample is measured for a haze of the stretched film in accordance with ASTM D1003 regulations using a haze meter (model name: Nippon Denshoku, NDH5000).

Hereinafter, the present invention will be described in more detail through specific Examples and Comparative Examples. In Examples and Comparative Examples, the density, melt index, and CFC analysis were measured according to the following methods.

### [Measurement Method]

### (1) Density

The measurement was performed in accordance with ASTM D1505.

### (2) Melt Index (MI)

The measurement was performed in accordance with ASTM D1238 under the conditions of 190° C. and a 2.16 kg load.

(3) a-TREF Analysis Using Cross-Fractionation Chromatography (CFC)

The CFC analysis was performed on a CFC instrument from Polymer Char, Valencia, Spain. The instrument includes a TREF column in the first dimension, a GPC column set in the second dimension, and an infrared detector (IR4 from Polymer Char) downstream of the GPC column. A sample to be analyzed was stirred at 150° C. for 80 minutes to be dissolved to a concentration of about 2.5 mg/ml in 1,2,3-trichlorobenzene. The solution was loaded in the center of the TREF column, stabilized at 100° C. for 45 minutes, and slowly cooled to 35° C. (0.5° C./min) to crystallize a polymer. Thereafter, the low temperature was maintained for 10 minutes, and then a soluble fraction was injected into the GPC column. All of GPC analysis was performed using a 1,2,4-trichlorobenzene solvent at 1 ml/min, a column temperature of 140° C. or lower, and in a “nested GPC injection.”

### (4) Thermal Properties

10 mg of a test piece was pre-melted at 220° C. for 5 minutes under a nitrogen gas atmosphere using a differential scanning calorimeter (trade name: DSC, manufactured by Perkin-Elmer Co.), and then the temperature was dropped to −100° C. at a temperature decrease rate of 5° C. Thereafter, the temperature was increased to 200° C. at a temperature increase rate of 10° C./min, and cooling was performed at a temperature decrease rate the same as the temperature increase rate to confirm the glass transition temperature Tg, the melting point temperature Tm, and the crystallization temperature Tc.

### EXAMPLES AND COMPARATIVE EXAMPLES

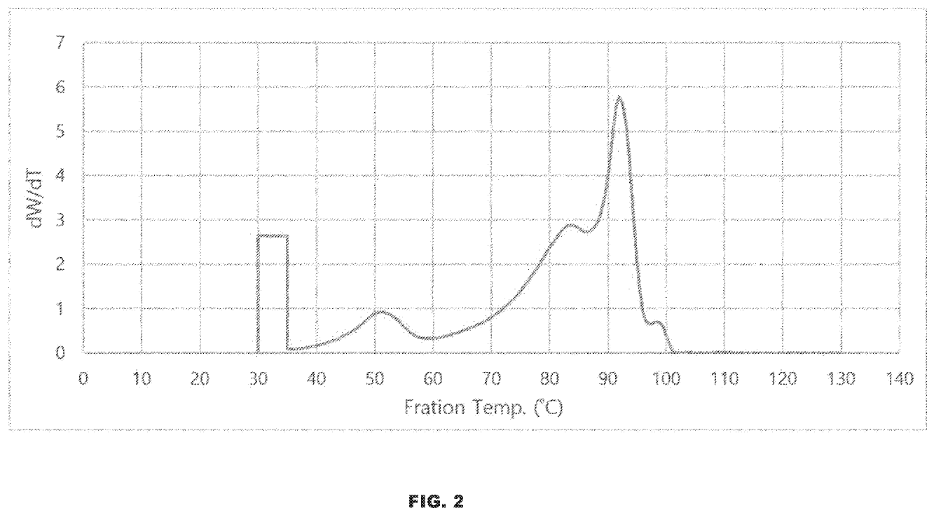

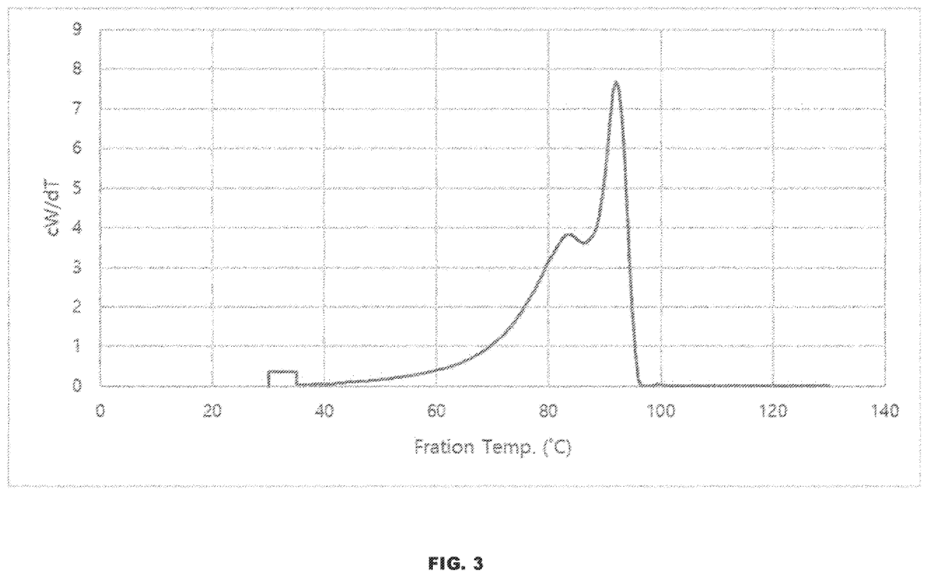

Compositions as shown in Table 1 and Table 2 were prepared, wherein in the case of a copolymer mixing composition (Examples 1 to 5, Comparative Examples 2, 3, 5, and 6), a copolymer of a corresponding combination was introduced into a twin-screw extruder and melt-blended under the condition of 180° C. to 220° C. to prepare a polyethylene resin composition in a pellet phase, and in the case of Comparative Examples 1 and 4, a copolymer was separately prepared without a mixing process. FIG. 2 and FIG. 3 respectively show temperature-elution fractionation curves analyzed by temperature-increasing elution fractionation using TREF for the compositions prepared according to Example 1 and Comparative Example 1.

### Experimental Examples

Using the above-described resin composition, a biaxially stretched film having a film thickness of 20 μm and a film width of 8 m was manufactured under the conditions of a molding rate of 400 m/min, a longitudinal direction (MD) stretching ratio of 5 times and a stretching temperature of 112° C. to 128° C., a transverse stretching ratio of 9 times and a stretching temperature of 108° C. to 116° C., and a sample of the biaxially stretched film was measured for a tensile strength in accordance with ASTM D882 regulations using a tensile tester (model name: Instron, 4466) under the conditions of a load cell of 100 N and a test rate of 500 mm/min, and then, the manufactured film was cut to a length of 1 m, and measured for a thickness at any point of 8 divided sections thereof to obtain a deviation in comparison with a thickness before stretching, thereby measuring a stretching thickness deviation by averaging the deviations, and the sample was measured for a haze of the stretched film in accordance with ASTM D1003 regulations using a haze meter (model name: Nippon Denshoku, NDH5000). The stretching thickness deviation is an index indicating stretching processability, and is marked as ‘⊚’ for a thickness deviation of 10% or less, ‘∘’ for a thickness deviation of 15% or less, ‘Δ’ for a thickness deviation of greater than 15%, and ‘X’ for fracture.

TABLE 1

| Classification | Example 1 | | | Example 2 | | | Example 3 | | |
|---|---|---|---|---|---|---|---|---|---|
| Copolymer | A | B | C | A | B | C | A | B | C |
| Melt index | 1 | 2.5 | 0.3 | 1 | 2.5 | 0.3 | 1 | 2 | 0.3 |
| (g/10 min) | | | | | | | | | |
| Density | 0.88 | 0.93 | 0.96 | 0.88 | 0.93 | 0.96 | 0.88 | 0.93 | 0.95 |
| (g/cm³) | | | | | | | | | |
| Comonomer | C8 | C4 | C4 | C8 | C4 | C4 | C8 | C6 | C4 |
| Tg | −45 | — | — | −45 | — | — | −45 | — | — |
| Tm | — | 126 | 134 | — | 126 | 134 | — | 126 | 133 |
| Tc | — | 112 | 118 | — | 112 | 118 | — | 113 | 117 |
| Composition | 20 | 75 | 5 | 20 | 70 | 10 | 25 | 72 | 3 |
| ratio (wt %) | | | | | | | | | |

| Final melt index | | 1.7 | 1.6 | 1.6 |
|---|---|---|---|---|
| (g/10 min) | | | | |
| Final density | | 0.926 | 0.928 | 0.926 |
| (g/cm³) | | | | |
| a-TREF | 35° C. | 12 | 10 | 15 |
| Weight | or | | | |
| fraction | lower | | | |
| (%) | 94° C. | 10 | 15 | 7 |
| | or | | | |
| | higher | | | |
| Stretching | | ⊚ | ∘ | ⊚ |
| processability | | | | |
| Tensile | MD | 750 | 800 | 700 |
| strength | TD | 1200 | 1500 | 1000 |
| (kgf/cm³) | | | | |

| | | | |
|---|---|---|---|
| Haze (%) | 6 | 7 | 5.5 |

| Classification | Example 4 | | | Example 5 | | |
|---|---|---|---|---|---|---|
| Copolymer | A | B | C | A | B | C |
| Melt index | 3.5 | 1.5 | 0.3 | 1 | 2.5 | 0.3 |
| (g/10 min) | | | | | | |
| Density | 0.91 | 0.93 | 0.95 | 0.88 | 0.93 | 0.96 |
| (g/cm³) | | | | | | |
| Comonomer | C6 | C4 | C6 | C8 | C8 | C4 |
| Tg | −45 | — | — | −45 | — | — |
| Tm | — | 126 | 133 | — | 126 | 134 |
| Tc | — | 112 | 117 | — | 112 | 118 |
| Composition | 30 | 65 | 5 | 20 | 75 | 5 |
| ratio (wt %) | | | | | | |

| Final melt index | | 2.3 | 1.7 |
|---|---|---|---|
| (g/10 min) | | | |
| Final density | | 0.932 | 0.926 |
| (g/cm³) | | | |
| a-TREF | 35° C. | 20 | 12 |
| Weight | or | | |
| fraction | lower | | |
| (%) | 94° C. | 11 | 11 |
| | or | | |
| | higher | | |
| Stretching | | ∘ | ⊚ |
| processability | | | |
| Tensile | MD | 710 | 780 |
| strength | TD | 950 | 1400 |
| (kgf/cm³) | | | |

| | | |
|---|---|---|
| Haze (%) | 8 | 6 |

* Notes
Comonomer: C4 (1-butene), C6 (1-hexene), C8 (1-octene)
Stretching direction: MD (longitudinal direction), TD (transverse direction)
Copolymer A: Metallocene-based ultra-low density polyethylene
Copolymer B: Ziegler-Natta-based linear low-density polyethylene
Copolymer C: High-density polyethylene

TABLE 2

| | Comparative | Comparative | | Comparative | | Comparative | Comparative | | | Comparative | | |
|---|---|---|---|---|---|---|---|---|---|---|---|---|
| Classification | Example 1 | Example 2 | | Example 3 | | Example 4 | Example 5 | | | Example 6 | | |
| Copolymer | B | A | B | B | C | B | A | B | C | A | B | C |
| Melt index | 3.2 | 1 | 2.5 | 2.5 | 0.3 | 2 | 1 | 2.5 | 0.3 | 1 | 2.5 | 0.3 |
| (g/10 min) | | | | | | | | | | | | |
| Density (g/cm³) | 0.93 | 0.88 | 0.94 | 0.93 | 0.96 | 0.92 | 0.88 | 0.93 | 0.96 | 0.88 | 0.93 | 0.96 |
| Comonomer | C4 | C8 | C4 | C4 | C4 | C6 | C8 | C4 | C4 | C8 | C4 | C4 |
| Tg | — | −45 | — | — | — | — | −45 | — | — | −45 | — | — |
| Tm | 124 | — | 126 | 124 | 134 | 128 | — | 124 | 134 | — | 124 | 134 |
| Tc | 113 | — | 114 | 112 | 118 | 115 | — | 112 | 118 | — | 112 | 118 |
| Composition | 100 | 20 | 80 | 95 | 5 | 100 | 18 | 70 | 12 | 40 | 55 | 5 |
| ratio (wt %) | | | | | | | | | | | | |

| Final melt index | | 3.2 | 2.1 | 2.2 | 2 | 1.9 | 1.6 |
|---|---|---|---|---|---|---|---|
| (g/10 min) | | | | | | | |
| Final density | | 0.938 | 0.925 | 0.936 | 0.926 | 0.929 | 0.916 |
| (g/cm³) | | | | | | | |
| a-TREF | 35° C. | 2 | 20 | 1.8 | 5 | 12 | 32 |
| Weight | or | | | | | | |
| fraction | lower | | | | | | |
| (%) | 94° C. | 4 | 3 | 10 | 1 | 17 | 3 |
| | or | | | | | | |
| | higher | | | | | | |
| Stretching | | X | Δ | X | Δ | X | Δ |
| processability | | | | | | | |
| Tensile | MD | — | 200 | — | 250 | — | 100 |
| strength | TD | — | 400 | — | 350 | — | 150 |
| (kgf/cm³) | | | | | | | |

| | | | | | | |
|---|---|---|---|---|---|---|
| Haze (%) | — | 15 | — | 5 | — | 5 |

* Notes
Comonomer: C4 (1-butene), C6 (1-hexene), C8 (1-octene)
Stretching direction: MD (longitudinal direction), TD (transverse direction)
Copolymer A: Metallocene-based ultra-low density polyethylene
Copolymer B: Ziegler-Natta-based linear low-density polyethylene
Copolymer C: High-density polyethylene

Referring to Table 1, in the case of a film (Examples 1 to 5) manufactured using a resin composition exhibiting a certain range of a TREF weight fraction, which is the resin composition having a certain range of melt index and density, and furthermore, having a certain range of glass transition temperature, melting point temperature, or crystallization temperature, and prepared using a specific comonomer by including a mixture of the (A) ultra-low density polyethylene, the (B) linear low-density polyethylene, and the (C) high-density polyethylene, it can be confirmed that the film is biaxially stretchable in a wider temperature range, and has excellent thickness smoothness and color properties.

In this regard, referring to Table 2, in the case of the (B) linear low-density polyethylene alone (Comparative Examples 1 and 4), it can be seen that there is a problem in that fracture occurs during stretching or the thickness deviation is greater than 15%, and biaxial stretching properties are poor beyond a desired TERF weight fraction.

In addition, even in the case in which the high-density polyethylene is not mixed (Comparative Example 2) or the (A) ultra-low density polyethylene is not mixed (Comparative Example 3), it can be seen that there is also a problem in that fracture occurs during stretching or the thickness deviation is greater than 15%, and biaxial stretching properties are poor beyond a desired TERF weight fraction.

In addition, it has been confirmed that even when all of the (A) to (C) copolymers are mixed, if the content of the (C) high-density polyethylene is excessive (Comparative Example 5), it is impossible to achieve stretching in a stretching process due to a large number of crystalline molecules, so that fracture occurs, and if the content of the (A) ultra-low density polyethylene is excessive (Comparative Example 6), mechanical properties are degraded due to a large number of low-crystalline molecules, thereby degrading a final tensile strength, so that it is difficult to achieve application to an actual product.

The preferred embodiments of the present invention have been described in detail. The description of the present invention has been presented for purposes of illustration, and it will be understood by those skilled in the art that various changes in form and details may be made therein without departing from the spirit and scope of the invention.

Therefore, the scope of the present invention is represented by the following claims rather than the above detailed description, and all changes and changed forms derived from the meaning, scope, and equivalent concepts of the claims should be construed as being included in the scope of the present invention.

1. A polyethylene resin composition for a biaxially oriented film, the composition comprising:
5 wt % to 20 wt % of a molecular weight fraction fractionated at a temperature of 35° C. or lower; and
5 wt % to 20 wt % of a molecular weight fraction fractionated at a temperature of 94° C. or higher through analytical temperature rising elution fractionation (a-TREF) analysis.

2. The polyethylene resin composition of claim 1, wherein the resin composition comprises:
(A) 1 wt % to 30 wt % of a copolymer of ethylene and an olefin having 4 to 10 carbon atoms, the copolymer having a density of 0.860 g/cm³ to 0.910 g/cm³;
(B) 60 wt % to 98 wt % of a copolymer of ethylene and an olefin having 4 to 10 carbon atoms, the copolymer having a density of 0.925 g/cm³ to 0.940 g/cm³; and
(C) 1 wt % to 10 wt % of a copolymer of ethylene and an olefin having 4 to 10 carbon atoms, the copolymer having a density of 0.940 g/cm³ to 0.970 g/cm³.

3. The polyethylene resin composition of claim 2, wherein the (A) copolymer has a melt index (190° C., 2.16 kg load) of 0.2 g/10 min to 6 g/10 min, the (B) copolymer has a melt index (190° C., 2.16 kg load) of 1 g/10 min to 3.5 g/10 min, and the (C) copolymer has a melt index (190° C., 2.16 kg load) of 0.2 g/10 min to 2.5 g/10 min.

4. The polyethylene resin composition of claim 3, wherein the (A) copolymer has a glass transition temperature (Tg) of −50° C. to −45° C., the (B) copolymer has a melting point temperature (Tm) of 120° C. 130° C. and a crystallization temperature (Tc) of 110° C. to 115° C., and the (C) copolymer has a melting point temperature (Tm) of 130° C. to 140° C. and a crystallization temperature (Tc) of 115° C. to 125° C.

5. The polyethylene resin composition of claim 1, wherein the resin composition has a melt index (190° C., 2.16 kg load) of 1 g/10 min to 3 g/10 min, and a density of 0.920 g/cm³ to 0.940 g/cm³.

6. The polyethylene resin composition of claim 1, wherein the resin composition has a tensile strength of 700 kgf/cm² or greater in each of longitudinal and transverse directions measured under the following conditions, a stretching thickness deviation of 15% or less, and a haze of 10% or less.
[Measurement method]
Using the above-described resin composition, a biaxially stretched film having a film thickness of 20 μm and a film width of 8 m is manufactured under the conditions of a molding rate of 400 m/min, a longitudinal direction (MD) stretching ratio of 5 times and a stretching temperature of 112° C. to 128° C., a transverse stretching ratio of 9 times and a stretching temperature of 108° C. to 116° C., and a sample of the biaxially stretched film is measured for a tensile strength in accordance with ASTM D882 regulations using a tensile tester (model name: Instron, 4466) under the conditions of a load cell of 100 N and a test rate of 500 mm/min, and then, the manufactured film is cut to a length of 1 m, and measured for a thickness at any point of 8 divided sections thereof to obtain a deviation in comparison with a thickness before stretching, thereby measuring a stretching thickness deviation by averaging the deviations, and the sample is measured for a haze of the stretched film in accordance with ASTM D1003 regulations using a haze meter (model name: Nippon Denshoku, NDH5000).
